(19) United States
(12) Patent Application Publication
(10) Pub. No.: US 2009/0024532 A1
(43) Pub. Date: Jan. 22, 2009

(54) PHONE-MEDIATING TRADING METHOD

(75) Inventor: Pan Chien-Ming, Taipei (TW)

Correspondence Address: EDWARDS ANGELL PALMER & DODGE LLP, P.O. BOX 55874, BOSTON, MA, 02205, US

(73) Assignees: WISTRON CORPORATION, Taipei (TW); ACER INCORPORATED, Taipei (TW)

(21) Appl. No.: 12/237,783

(22) Filed: Sep. 25, 2008

Related U.S. Application Data
(62) Division of application No. 10/190,289, filed on Jul. 3, 2002.

(30) Foreign Application Priority Data
Jul. 3, 2001 (TW) 090116209

(51) Int. Cl. H04L 9/00; G06Q 40/00

(52) U.S. Cl. 705/64; 705/80; 705/37

(57) ABSTRACT

A phone-mediating trading system and a method for use with the same are provided. After the user uses a user phone to construct linkage to the trading host, the trading host generates a set of random data to the user phone where the set of random data is encrypted with a private key designated to the user phone. The encrypted set of random data is transmitted to the trading host, and decrypted through the use of a public key that is stored in the trading host and corresponds to the user's phone number. If the decrypted set of random data, as determined by the trading host, is the same as the originally-generated set of random data, the user is allowed to perform trading with the trading host. This method is efficient and convenient to implement without performing a conventional complex identification process for identifying the user.

### FIELD OF THE INVENTION

The present invention relates to trading systems and methods, and more particularly, to a phone-mediating trading system and method for use with a phone that stores security data for identity recognition, whereby a user is allowed to dial a dedicated phone number for directly trading with a designated bank or shop without having to proceed with a complex identification process, thereby improving efficiency and convenience for phone-mediating commerce.

### BACKGROUND OF THE INVENTION

As electronic and communication technology greatly advances, it is getting popularized to perform trading (e.g. making a purchase, declaring tax, etc) with banks, shops and government organizations via network- or phone-mediating electronic commerce (e-commerce). Such a trading method is desirably time-effective and convenient to implement, by which users do not need to in person wait for the queue and deal with clerks in charge.

In proceeding of phone-mediating commerce with a bank, a user normally dial a customer-service number, and then, a customer serving terminal asks the user about questions for identity verification; for example, if the customer serving terminal is set with a programmed phonetic inquiry system, the user may need to use phone keys for inputting data of identification number, date of birth, bank account number and the like to the phonetic inquiry system, so as to allow the bank to recognize the user's identity.

Such a complex identification process is time-consuming, and possibly inherent with problems of errors in manipulation; for example, mistakes may occur for built-up of user data in the programmed phonetic inquiry system, or the user may accidentally input wrong identification data to the phonetic inquiry system.

Therefore, in response to the above drawbacks, the problem to be solved herein is to provide a phone-mediating trading system and method, allowing phone-mediating commerce to be efficiently and safely performed.

### SUMMARY OF THE INVENTION

A primary objective of the present invention is to provide a phone-mediating trading system and method for use with a phone that stores security data for identity recognition, whereby a user is allowed to dial a dedicated phone number for directly trading with a designated bank or shop without having to proceed with a complex identification process, thereby improving efficiency and convenience for phone-mediating commerce.

In accordance with the above and other objectives, the present invention proposes a phone-mediating trading system and method. The phone-mediating trading system comprises: a public telephone system for mediating telephone communication; a user phone coupled to the public telephone system, for allowing a user to be linked to the public telephone system, wherein a private key is designated to and stored in the user phone, and used for identification of the user; and at least a trading host coupled to the public telephone system, for allowing the user of the user phone to be linked to and perform trading with the trading host via the public telephone system, wherein the trading host stores a private key designated thereto, and a plurality of public keys corresponding to the user and other trading hosts linked thereto via the public telephone system.

The phone-mediating trading method is used for allowing a user with a user phone to be linked to at least a trading host via a public telephone system, and comprises the steps of: (1) constructing linkage via the user phone to the trading host through the public telephone system, and asking the user to input identity-identification data to the trading host; (2) generating a set of random data via the trading host to the user phone; (3) encrypting the set of random data via the user phone through the use of a private key that is designated to and stored in the user phone, and transmitting the encrypted set of random data to the trading host; (4) decrypting the encrypted set of random data via the trading host through the use of a public key that is stored in the trading host and corresponds to the user's phone number; (5) determining via the trading host if the decrypted set of random data is the same as the original set of random data generated from the trading host; if no, proceeding to step (6); if yes, proceeding to step (7); (6) prohibiting the user from performing phone-mediating trading with the trading host as the decrypted set of random data is different from the originally-generated set of random data, which indicates the private key stored in the user phone is incorrect; and (7) permitting the user to perform phone-mediating trading with the trading host as the decrypted set of random data is the same as the originally-generated set of random data, which indicates the private key stored in the user phone is correct.

By using the above phone-mediating system and method, a user can efficiently and conveniently perform trading with a trading host through the use of a private key that is designated to and stored in a user phone of the user, without having to implement a conventional complex identification process for identifying the user in respect of trading performance.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing architecture of a phone-mediating trading system according to an embodiment of the invention;

FIG. 2 is a block diagram showing architecture of a trading host used in the phone-mediating trading system of FIG. 1;

FIG. 3 is a block diagram showing architecture of a user phone used in the phone-mediating trading system of FIG. 1;

FIGS. 4(A) and 4(B) are flowcharts showing process steps of a phone-mediating trading method according to the invention, for performing trading between a user phone and a bank host;

FIG. 5 is a schematic diagram showing data transmission between the user phone and the bank host in the phone-mediating trading method of FIGS. 4(A) and 4(B);

FIGS. 6(A)-6(C) are flowcharts showing process steps of the phone-mediating trading method according to the invention, for performing trading between the user phone and a trader host;

FIG. 7 is a schematic diagram showing data transmission between the user phone and the trader host in the phone-mediating trading method of FIGS. 6(A)-6(C);

FIGS. 8(A)-8(C) are flowcharts showing process steps of the phone-mediating trading method according to the invention, for performing a billing process by the trader host to the bank host; and

FIG. 9 is a schematic diagram showing data transmission between the bank host and the trader host in the phone-mediating trading method of FIGS. 8(A)-8(C).

### DETAILED DESCRIPTION OF THE PREFERRED EMBODIMENT

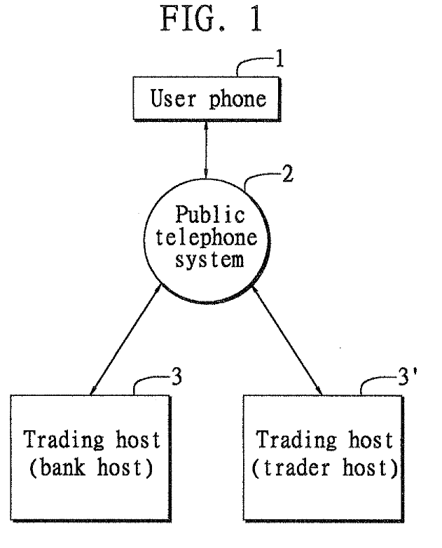

FIG. 1 illustrates architecture of a phone-mediating trading system according to an embodiment of the present invention, which includes a user phone 1, a public telephone system or public switched telephone network (PSTN) 2, and a plurality of trading hosts 3, 3′. A user having the user phone 1 is allowed to dial a dedicated service number provided from the trading hosts 3, 3′, whereby the user phone 1 can be linked to the trading hosts 3, 3′ via the PSTN 2 for trading performance.

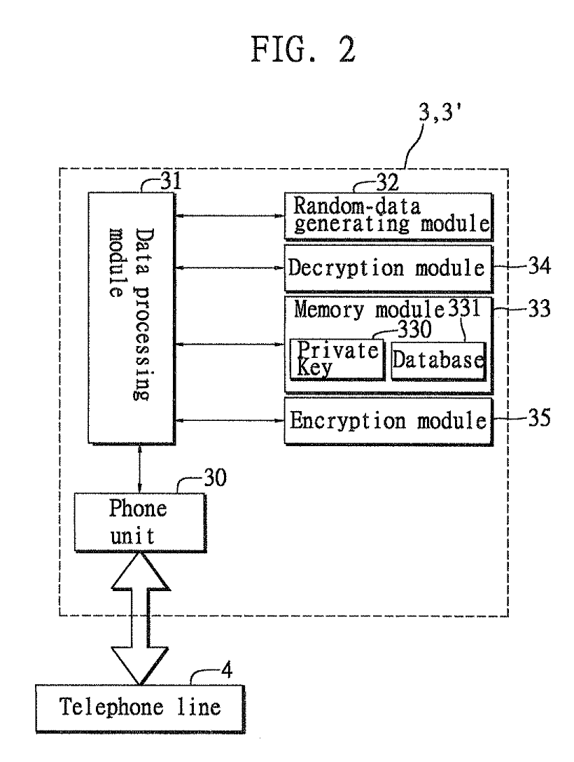

FIG. 2 illustrates architecture of a trading host 3, 3′ shown in FIG. 1. As shown in FIG. 2, the trading host 3, 3′ includes a phone unit 30, a data processing module 31, a random-data generating module 32, a memory module 33, a decryption module 34, and an encryption module 35.

The phone unit 30 is coupled to the PSTN 2 via telephone wires 4, and provides functions of a normal telephone, such as number-dialing, call-connection/disconnection, telephone communication, ringing and the like.

The data processing module 31 is coupled to the phone unit 30, so as to process trading data provided from users or other trading hosts, and determine identity or authorization of the users or other trading hosts in respect of trading performance, as well as to proceed with data communication, logic and operations, and coordination and control for other components connected thereto.

The random-data generating module 32 is coupled to the data processing module 31, for generating a set of random data to the user phone 1 or other trading hosts for the purpose of identity identification.

The memory module 33 is coupled to the data processing module 31, and provided with a database 331 for storing at least a private key 330 and a plurality of public keys. The private key 330 is designated uniquely to the trading host 3, 3′ having the memory module 33 for identification purpose. The public keys are established correspondingly to the user's phone number and phone numbers of other trading hosts respectively; that is, each phone number is designated with a unique public key for identification purpose.

The decryption module 34 is coupled to the data processing module 31, for decrypting data through the use of a public key retrieved by the data processing module 31 from the database 331 of the memory module 33.

The encryption module 35 is coupled to the data processing module 31, for encrypting data through the use of a private key 330 retrieved by the data processing module 31 from the database 331 of the memory module 33 for the sake of secure data transmission.

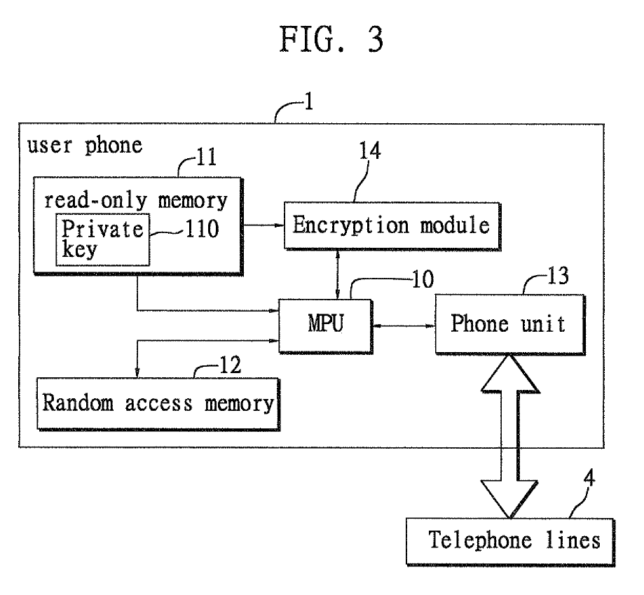

FIG. 3 illustrates architecture of a user phone 1 shown in FIG. 1. As shown in FIG. 3, the user phone 1 includes a microprocessor 10, a read-only memory (ROM) 11, a random access memory (RAM) 12, an encryption module 13, and a phone unit 14.

The microprocessor 10 acts as a central processing unit to be connected with other components of the user phone 1. The microprocessor 10 is primarily used to execute system programs and function programs, and to proceed with data communication, logic and operations, and coordination and control for other components connected thereto.

The ROM 11 is coupled to the microprocessor 10, for storing system programs and function programs preset in the user phone 1 as well as a private key 110 used for identifying a user by the trading hosts 3, 3′.

The RAM 12 is provided with an extended access memory region, and directly coupled to the microprocessor 10. The RAM 12 is used to store work parameters of the microprocessor 10, and acts as a temporary work area for trading between the user phone 1 and the trading hosts 3, 3′ in a manner as to repetitively read/write data from/into the RAM 12.

The encryption module 13 is coupled to the microprocessor 10 and the ROM 11. During phone-mediating trading between the user and the trading hosts 3, 3′, the encryption module 13 retrieves the private key 110 of the user phone 1 from the ROM 11, and encrypt data with the private key 110 for secure data transmission.

The phone unit 14 is coupled to the microprocessor 10, and provides functions of a normal telephone, such as number-dialing, call-connection/disconnection, telephone communication, ringing and the like, The phone unit 14 is further coupled to the PSTN 2 via telephone wires 4 for data transmission between the user phone 1 and the trading hosts 3, 3′.

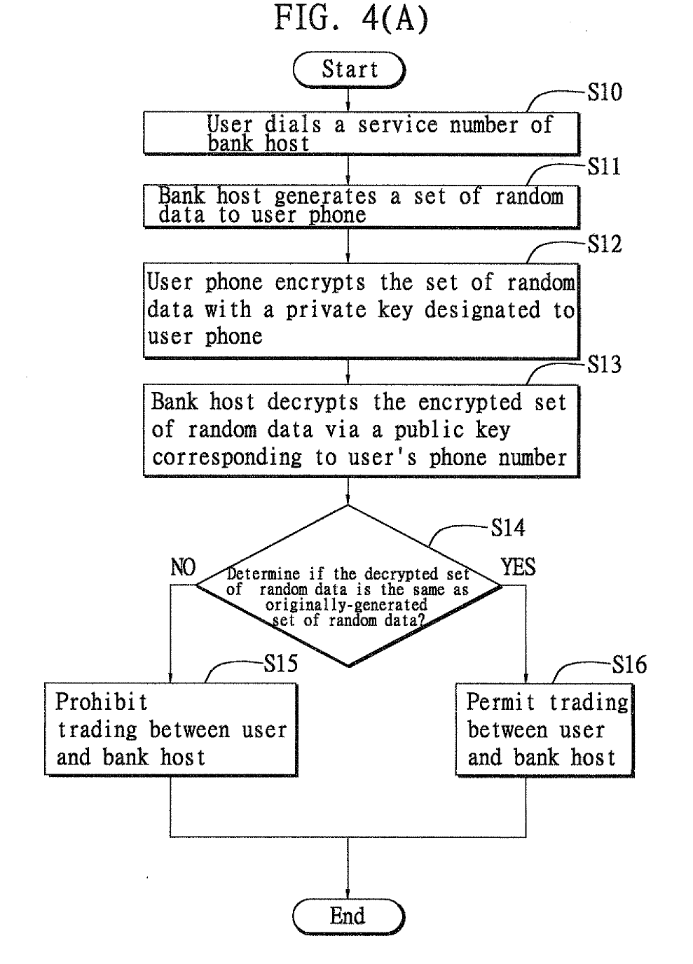

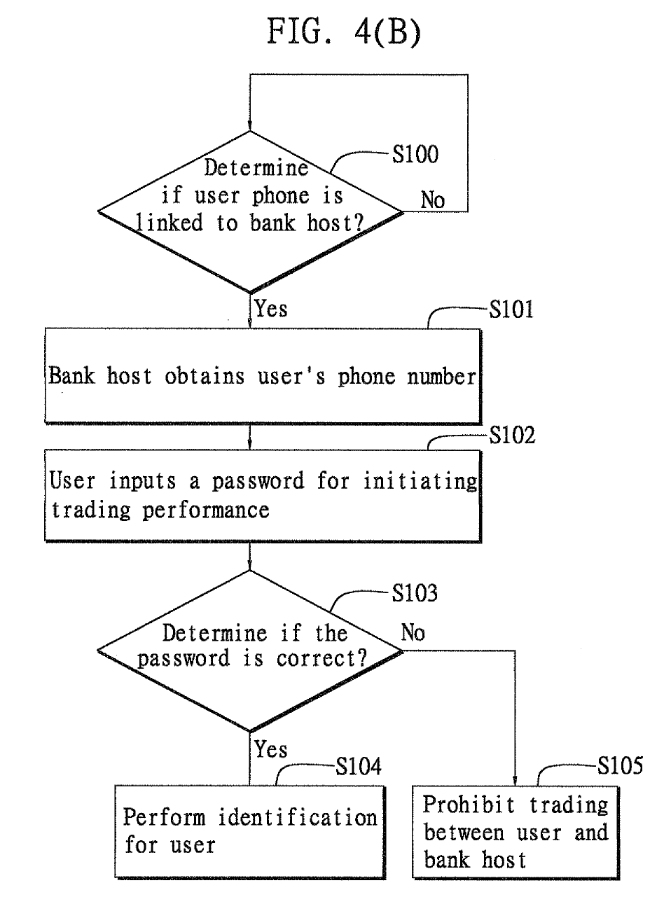

By using the above phone-mediating trading system shown in FIGS. 1-3, a phone-mediating trading method can be performed and described as follows with references to FIGS. 4-9.

FIGS. 4(A) and 4(B) illustrate process steps of a phone-mediating trading method according to the invention, for performing trading between a user phone 1 and a trading host (bank host) 3. As shown in FIG. 4(A), first in step S10, a user uses the user phone 1 to dial a service number provided from the bank host 3. Then, it proceeds to step S11.

In step S11, after the user phone 1 is successfully linked to the bank host 3 via the PSTN 2, a random-data generating module 32 of the bank host 3 generates and forwards a set of random data to the user phone 1. Then, it proceeds to step S12.

In step S12, upon receiving the set of random data from the bank host 3, an encryption module 13 of the user phone 1 encrypts the set of random data with a private key 110 stored in a ROM 11 of the user phone 1, and the encrypted set of random data is transmitted to the bank host 3. Then, it proceeds to step S13.

In step S13, upon receiving the encrypted set of random data from the user phone 1, the bank host 3 searches in a database 331 of a memory module 33 thereof for a public key corresponding to the user's phone number, whereby a decryption module 34 of the bank host 3 decrypts the encrypted set of random data with the public key. Then, it proceeds to step S14.

In step S14, the bank host 3 determines if the decrypted set of random data is the same as the original set of random data generated from the bank host 3; if no, it proceeds to step S15; if yes, it proceeds to step S16.

In step S15, as the decrypted set of random data is not the same as the originally-generated set of random data, it indicates that the private key 110 stored in the user phone 1 is not correct, and thus the user is not allowed for phone-mediating trading with the bank host 3.

In step S16, as the decrypted set of random data is the same as the originally-generated set of random data, it indicates that the private key 110 stored in the user phone 1 is correct, and thus the user is allowed for phone-mediating trading with the bank host 3.

FIG. 4(B) illustrates more detailed processes for step S10 of FIG. 4(A). As shown in FIG. 4(B), first in step S100, it determines if the user phone 1 is successfully linked to the bank host 3 via the PSTN 2; if yes, it proceeds to step S101; if no, it repeats step S100.

In step S101, the bank host 3 obtains the user's phone number. Then, it proceeds to step S102.

In step S102, the user inputs a password for initiating phone-mediating trading with the bank host 3. Then, it proceeds to step S103.

In step S103, the bank host 3 determines if the password inputted by the user is correct according to the user's phone number obtained thereby; if yes, it proceeds to step S104; if no, it proceeds to step S105.

In step S104, the bank host 3 starts to perform an identification process for the user, and it proceeds to step S11.

In step S105, the user is not allowed for phone-mediating trading with the bank host 3.

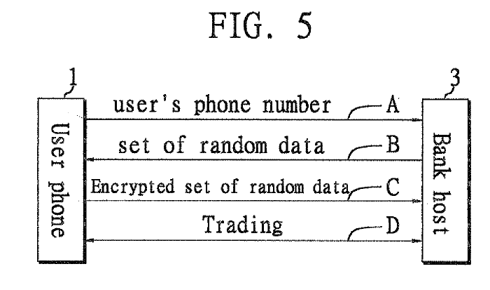

FIG. 5 illustrates data transmission between the user phone 1 and the bank host 3 in the phone-mediating trading method of FIGS. 4(A) and 4(B). After the user phone 1 is successfully linked to the bank host 3 via the PSTN 2, the bank host 3 obtains the user's phone number A, and asks the user to input a password for initiating phone-mediating trading with the bank host 3. If the inputted password, determined by the bank host 3, is correct, the bank host 3 forwards a set of random data B to the user phone 1, which then encrypts the set of random data B with a private key stored in the ROM 11 thereof to form the encrypted set of random data C and transmits the encrypted set of random data C back to the bank host 3. Then, the bank host 3 searches in the database 331 of the memory module 33 for a public key corresponding to the user's phone number A obtained thereby, and decrypts the encrypted set of random data C with the public key; if the decrypted set of random data is the same as the original set of random data forwarded from the bank host 3, the user is allowed to perform trading with the bank host 3.

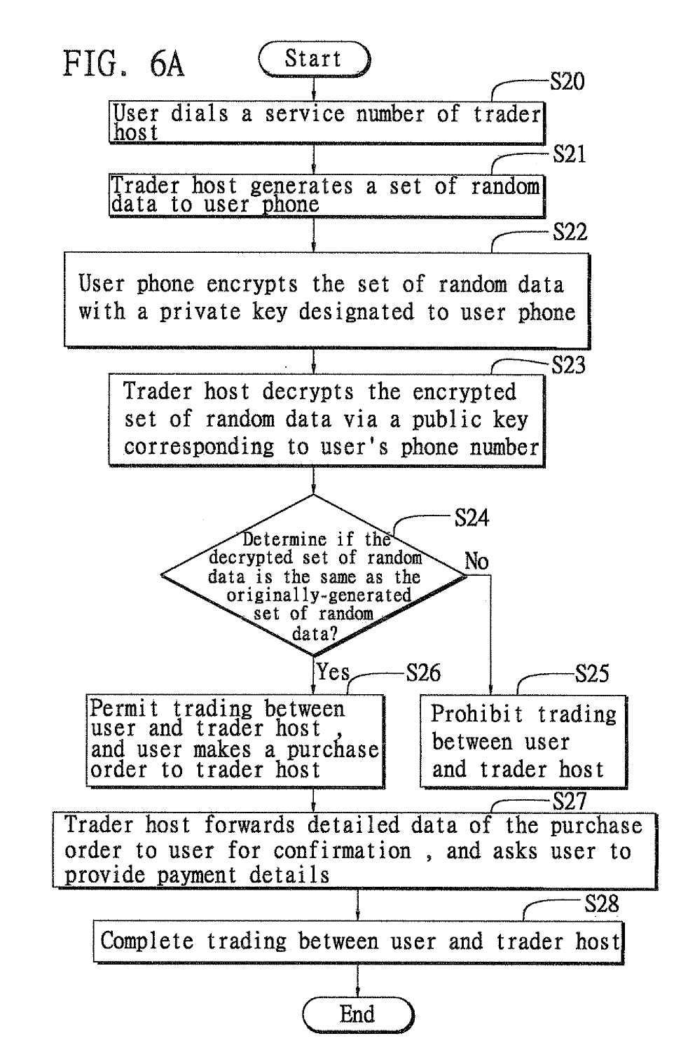

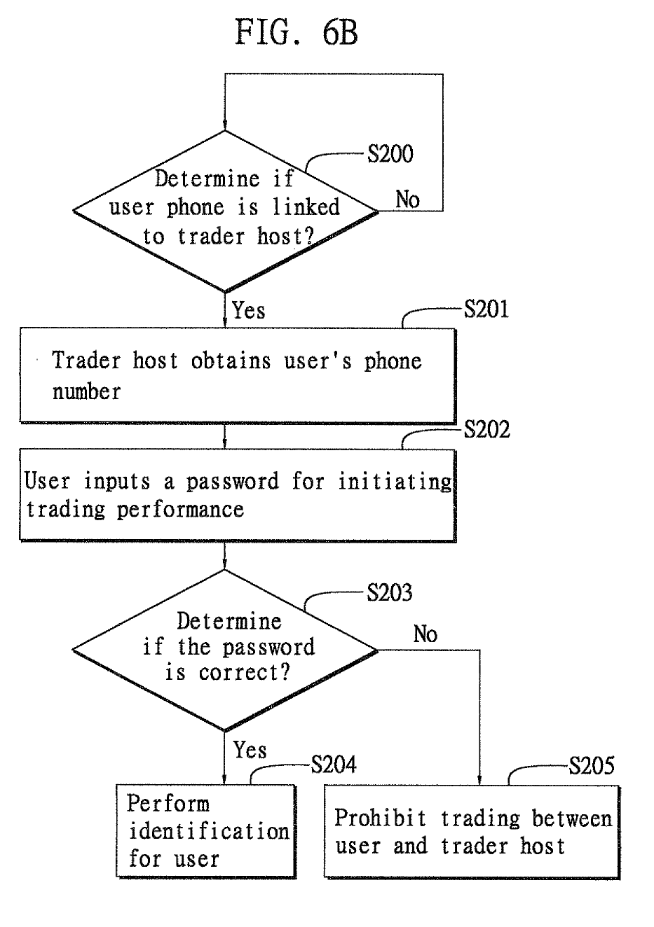

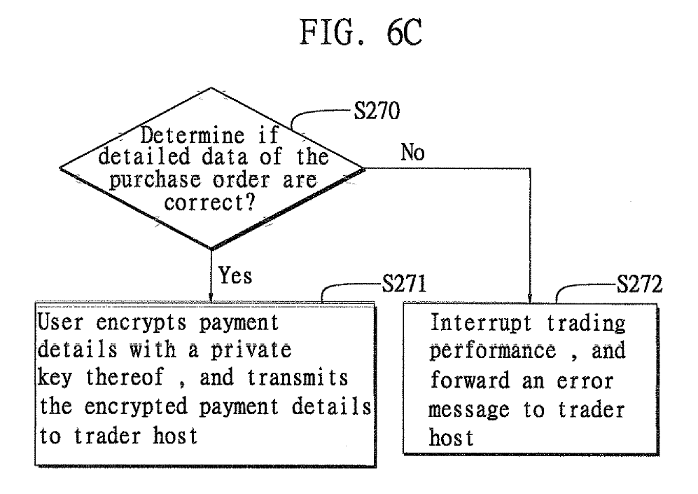

FIGS. 6(A)-6(C) illustrate process steps of the phone-mediating trading method according to the invention, for performing trading between the user phone 1 and a trading host (trader host) 3′. As shown in FIG. 6(A), first in step S20, a user uses the user phone 1 to dial a service number provided from the trader host 3′. Then, it proceeds to step S21.

In step S21, after the user phone 1 is successfully linked to the trader host 3′ via the PSTN 2, a random-data generating module 32 of the trader host 3′ generates and forwards a set of random data to the user phone 1. Then, it proceeds to step S22.

In step S22, upon receiving the set of random data from the trader host 3′, an encryption module 13 of the user phone 1 encrypts the set of random data with a private key 110 stored in a ROM 11 of the user phone 1, and the encrypted set of random data is transmitted to the trader host 3′. Then, it proceeds to step S23.

In step S23, upon receiving the encrypted set of random data from the user phone 1, the trader host 3′ searches in a database 331 of a memory module 33 thereof for a public key corresponding to the user's phone number, whereby a decryption module 34 of trader host 3′ decrypts the encrypted set of random data with the public key. Then, it proceeds to step S24.

In step S24, the trader host 3′ determines if the decrypted set of random data is the same as the original set of random data generated from the trader host 3′; if no, it proceeds to step S25; if yes, it proceeds to step S26.

In step S25, as the decrypted set of random data is not the same as the originally-generated set of random data, it indicates that the private key 110 stored in the user phone 1 is not correct, and thus the user is not allowed for phone-mediating trading with the trader host 3′.

In step S26, as the decrypted set of random data is the same as the originally-generated set of random data, it indicates that the private key 110 stored in the user phone 1 is correct, and thus the user is allowed for phone-mediating trading with the trader host 3′ such as making a purchase order. Then, it proceeds to step S27.

In step S27, upon receiving the purchase order from the user, the trader host 3′ forwards detailed data listed in the purchase order back to the user for confirmation, and asks the user about payment details. Then, it proceeds to step S28.

In step S28, the user completes phone-mediating trading with the trader host 3′ and logs off the phone-mediating trading system.

FIG. 6(B) illustrates more detailed process for step S20 of FIG. 6(A). As shown in FIG. 6(B), first in step S200, it determines if the user phone 1 is successfully linked to the trader host 3′ via the PSTN 2; if yes, it proceeds to step S201; if no, it repeats step S200.

In step S201, the trader host 3′ obtains the user's phone number. Then, it proceeds to step S202.

In step S202, the user inputs a password for initiating phone-mediating trading with the trader host 3′. Then, it proceeds to step S203.

In step S203, the trader host 3′ determines if the password inputted by the user is correct according to the user's phone number obtained thereby; if yes, it proceeds to step S204; if no, it proceeds to step S205.

In step S204, the trader host 3′ starts to perform an identification process for the user, and it proceeds to step S21.

In step S205, the user is not allowed for phone-mediating trading with the trader host 3′.

FIG. 6(C) illustrates more detailed process for step S27 of FIG. 6(A). As shown in FIG. 6(C), first in step S270, the user determines if detailed data of the purchase order forwarded from the trader host 3′ are correct; if yes, it proceeds to step S271; if no, it proceeds to step S272.

In step S271, as detailed data of the purchase order are determined to be correct, the user uses the private key 110 stored in the user phone 1 to encrypt payment details, and transmits the encrypted payment details to the trader host 3′.

In step S272, as detailed data of the purchase order are determined to be incorrect, an error message is forwarded to the trader host 3′ for asking the trader host 3′ to revise the detailed data of the purchase order.

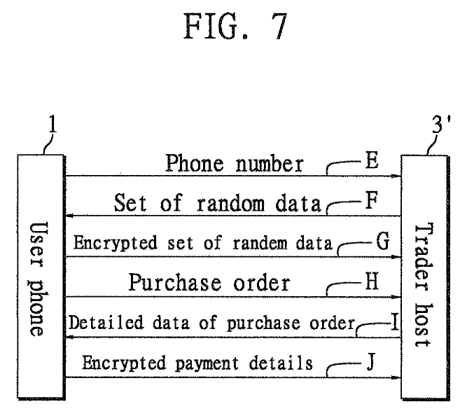

FIG. 7 illustrates data transmission between the user phone 1 and the trader host 3′ in the phone-mediating trading method of FIGS. 6(A)-6(C). After the user phone 1 is successfully linked to the trader host 3′ via the PSTN 2, the trader host 3′ obtains the user's phone number E, and asks the user to input a password for initiating phone-mediating trading with the trader host 3′. If the inputted password, determined by the trader host 3′, is correct, the trader host 3′ forwards a set of random data F to the user phone 1, which then encrypts the set of random data F with a private key stored in the ROM 11 thereof to form the encrypted set of random data G and transmits the encrypted set of random data G back to the trader host 3′. Then, the trader host 3′ searches in the database 331 of the memory module 33 for a public key corresponding to the user's phone number E obtained thereby, and decrypts the encrypted set of random data G with the public key; if the decrypted set of random data is the same as the original set of random data forwarded from the trader host 3′, the user is allowed to perform trading with the trader host 3′ such as making a purchase order H. Upon receiving the purchase order H from the user, the trader host 3′ forwards detailed data I listed in the purchase order H back to the user for confirmation. After the user determines the detailed data I are correct, payment details J of the user are encrypted with the private key 110 stored in the user phone 1 and transmitted to the trader host 3′.

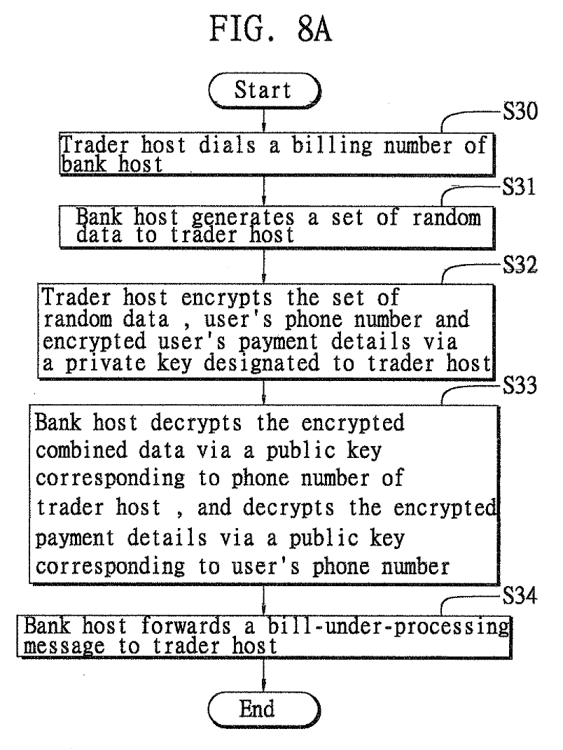

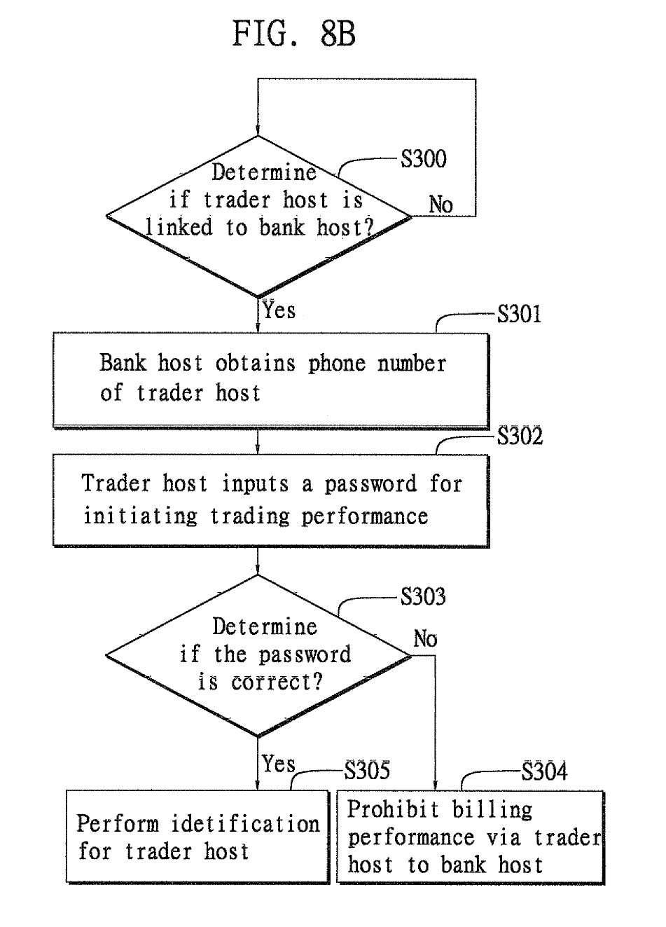

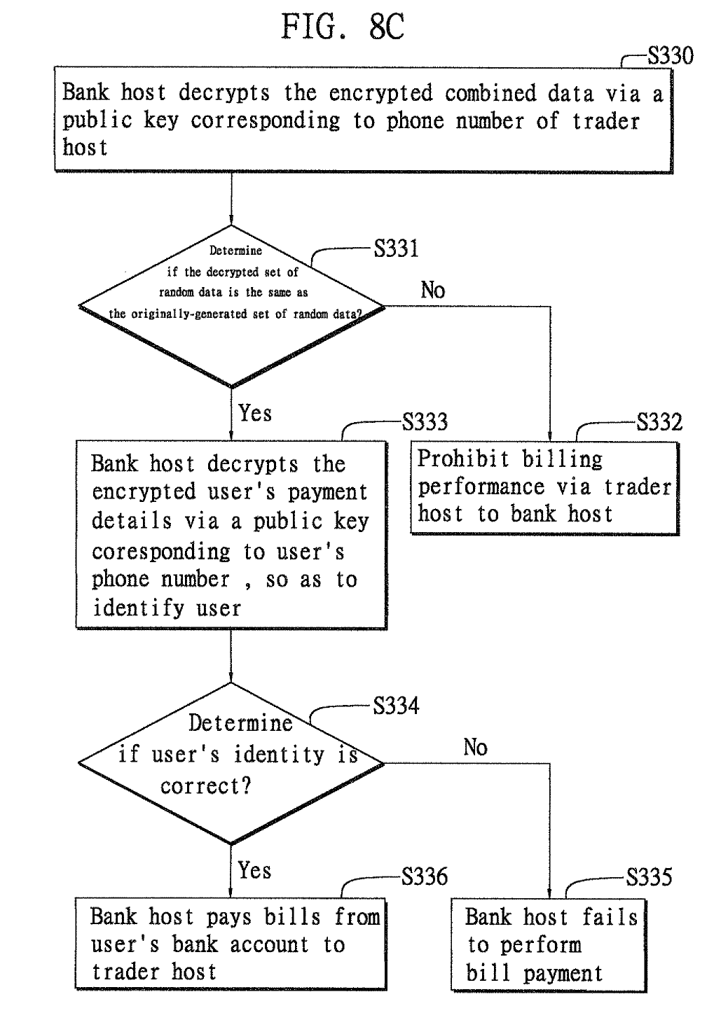

FIGS. 8(A)-8(C) illustrate process steps of the phone-mediating trading method according to the invention, for performing a billing process by the trader host 3′ to the bank host 3. When the user completes performance of phone-mediating trading with the trader host 3′, as above described with reference to FIGS. 6(A)-6(C) and 7, the trader host 3′ bills the bank host 3′ via the PSTN 2 according to payment details provided from the user. As shown in FIG. 8(A), first in step S30, the trader host 3′ dials a billing number provided from the bank host 3. Then, it proceeds to step S31.

In step S31, after the trader host 3′ is successfully linked to the bank host 3 via the PSTN 2, a random-data generating module 32 of the bank host 3 generates and forwards a set of random data to the trader host 3′. Then, it proceeds to step S32.

In step S32, upon receiving the set of random data from the bank host 3, an encryption module 35 of the trader host 3′ uses a private key 330 stored in a memory module 33 thereof to encrypt the set of random data, the user's phone number and the encrypted payment details provided from the user, allowing these encrypted combined data to be transmitted to the bank host 3. Then, it proceeds to step S33.

In step S33, upon receiving the encrypted combined data from the trader host 3′, the bank host 3 searches in a database 331 of a memory module 33 thereof for a public key corresponding to a phone number of the trader host 3′, so as to decrypt the encrypted combined data with this public key and to identify the trader host 3′. Further, the bank host 3 searches in the database 331 for another public key corresponding to the user's phone number, so as to decrypt the encrypted payment details of the user with this public key and to identify the user. Then, it proceeds to step S34.

In step S34, the bank host 3 forwards a bill-under-processing message to the trader host 3′.

FIG. 8(B) illustrates more detailed processes for step S30 of FIG. 8(A). As shown in FIG. 8(B), first in step S300, it determines if the trader host 3′ is successfully linked to the bank host 3 via the PSTN 2; if yes, it proceeds to step S301; if no, it repeats step S300.

In step S301, the bank host 3 obtains a phone number of the trader host 3′. Then, it proceeds to step S302.

In step S302, the trader host 3′ inputs a password for initiating a phone-billing process with the bank host 3. Then, it proceeds to step S303.

In step S303, the bank host 3 determines if the password inputted by the trader host 3′ is correct according to the phone number of the trader host 3′ obtained thereby, if yes, it proceeds to step S305; if no, it proceeds to step S304.

In step S304, the trader host 3′ is not allowed to perform the phone-billing process with the bank host 3.

In step S305, the bank host 3 starts to perform an identification process for the trader host 3′, and it proceeds to step S31.

FIG. 8(C) illustrates more detailed processes for step S33 of FIG. 8(A). As shown in FIG. 8(C), first in step S330, the bank host 3 searches in the database 331 of the memory module 33 for a public key corresponding to the phone number of the trader host 3′, and uses this public key to decrypt the encrypted combined data transmitted from the trader host 3′ for recognizing identity of the trader host 3′. The combined data encrypted with a private key stored in the memory module 33 of the trader host 3′, include a set of random data, the user's phone number and the user's encrypted payment details. Then, it proceeds to step S331.

In step S331, the bank host 3 determines if the decrypted set of random data is the same as the original set of random data generated by the bank host 3; if yes, it proceeds to step S333; if no, it proceeds to step S332.

In step S332, as the decrypted set of random data is not the same as the originally-generated set of random data, it indicates that identity of the trader host 3′ is not correct, and thus the trader host 3′ is not allowed to perform the phone-billing process.

In step S333, as the decrypted set of random data is the same as the originally-generated set of random data, which indicates identity of the trader host 3′ is correct, the bank host 3 retrieves from the database 331 of the memory module 33 thereof for a public key corresponding to the user's phone number, and uses the public key to decrypt the encrypted payment details, so as to determine identity of the user who provides the payment details. Then, it proceeds to step S334.

In step S334, the bank host 3 determines if identity of the user in the payment details is correct; if no, it proceeds to step S335; if yes, it proceeds to step S336.

In step S335, the bank host 3 notifies the trader host 3′ of incorrectness of the user's identity, such that bills cannot be paid to the trader host 3′.

In step S336, as the user's identity is determined to be correct, the bank host 3 pays the bills from the user's bank account to the trader host 3′, and it proceeds to step S34.

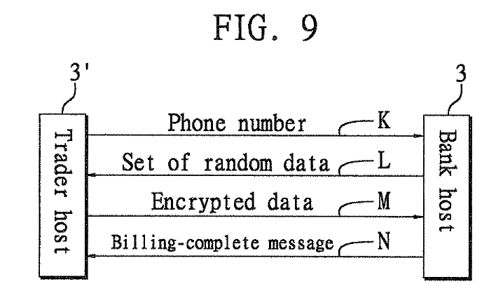

FIG. 9 illustrates data transmission between the bank host 3 and the trader host 3′ in the phone-mediating trading method of FIGS. 8(A)-8(C), so as to allow the trader host 3′ to perform a phone-billing process with the bank host 3 via the PSTN 2. After completing the phone-mediating trading between a user and the trader host 3′ (as above described with reference to FIGS. 6(A)-6(C) and 7), the trader host 3′ receives encrypted payment details from the user, and dials a billing number provided by the bank host 3, whereby the bank host 3 obtains a phone number K of the trader host 3′. Then, the bank host 3 asks the trader host 3′ to input a password for initiating the phone-billing process with the bank host 3. If the inputted password, determined by the bank host 3, is correct, the bank host 3 forwards a set of random data L to the trader host 3′, allowing the trader host 3′ to encrypt data including the set of random data L, the user's phone number and the user's encrypted payment details with a private key 330 stored therein, and to transmit the encrypted combined data M to the bank host 3. Then, the bank host 3 searches in the database 331 of the memory module 33 for a public key corresponding to the phone number of the trader host 3′, and uses the public key to decrypt the encrypted combined data M for obtaining decrypted set of random data. The decrypted set of random data is compared with an original set of random data forwarded from the bank host 3. If the decrypted set of random data is the same as the original set of random data forwarded from the bank host 3, it indicates identity of the trader host 3′ is correct, and the bank host 3 retrieves from the database 331 for a public key corresponding to the user's phone number, and uses this public key to decrypt the user's encrypted payment details to identify the user's identity. If identities of the trader host 3′ and the user are both determined to be correct, the bank host 3 pays bills from the user's bank account to the trader host 3′, and forwards a billing-complete message N to the trader host 3′.

Therefore, by using the above phone-mediating system and method, a user can efficiently and conveniently perform trading with a trading host through the use of a private key that is designated to and stored in a user phone of the user, without having to implement a conventional complex identification process for identifying the user in respect of trading performance.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1-7. (canceled)

8. A phone-mediating trading method, for allowing a user with a user phone to be linked to at least a trading host via a public telephone system; the phone-mediating trading method comprising the steps of:
(1) constructing linkage via the user phone to the trading host through the public telephone system, and asking the user to input identity-identification data to the trading host;
(2) generating a set of random data via the trading host to the user phone;
(3) encrypting the set of random data via the user phone through the use of a private key that is designated to and stored in the user phone, and than transmitting the encrypted set of random data to the trading host;
(4) decrypting the encrypted set of random data via the trading host through the use of a public key that is stored in the trading host and corresponds to the user's phone number;
(5) determining via the trading host if the decrypted set of random data is the same as the original set of random data generated from the trading host; if no, proceeding to step (6); if yes, proceeding to step (7);
(6) prohibiting the user from performing phone-mediating trading with the trading host as the decrypted set of random data is different from the originally-generated set of random data, which indicates the private key stored in the user phone is incorrect; and
(7) permitting the user to perform phone-mediating trading with the trading host as the decrypted set of random data is the same as the originally-generated set of random data, which indicates the private key stored in the user phone is correct.

9. The phone-mediating trading method of claim 8, wherein step (1) comprises the steps of:
(1-1) determining if the user phone is successfully linked to the trading host; if yes, proceeding to step (1-2); if no, repeating step (1-1);
(1-2) obtaining the user's phone number via the trading host;
(1-3) inputting via the user a password for initiating phone-mediating trading with the trading host;
(1-4) determining via the trading host according to the user's phone number if the inputted password is correct; if yes, proceeding to step (1-5); if no, proceeding to step (1-6);
(1-5) starting to perform an identification process for the user; and
(1-6) prohibiting the user from performing phone-mediating trading with the trading host.

10. The phone-mediating trading method of claim 9, wherein the trading host is a bank host.

11. The phone-mediating trading method of claim 9, after step (7), further comprising the steps of:
(8) transmitting trading data via the trading host to the user for confirmation, so as to allow the user to provide payment details for the trading host; and
(9) processing the payment details for completing phone-mediating trading between the user and the trading host.

12. The phone-mediating trading method of claim 11, wherein step (8) comprises the steps of:
(8-1) determining via the user if trading data transmitted from the trading host are correct; if yes, proceeding to step (8-2); if no, proceeding to step (8-3);
(8-2) encrypting the payment details through the use of the private key stored in the user phone, and transmitting the encrypted payment details to the trading host via the user phone as the trading data are determined to be correct; and
(8-3) interrupting phone-mediating trading with the trading host, and forwarding an error message to the trading host via the user phone as the trading data are determined to be incorrect, so as to allow the trading host to revise the incorrect trading data.

13. The phone-mediating trading method of claim 12, wherein the trading host is a trader host.

14. The phone-mediating trading method of claim 13, wherein the phone-mediating trading is to make a purchase with the trader host via the user.

15. The phone-mediating trading method of claim 12, wherein step (9) comprises the steps of:
(9-1) constructing linkage via the trading host to a transaction host via the public telephone system, and asking the trading host to input identity-identification data to the transaction host;
(9-2) generating a set of random data via the transaction host to the trading host;
(9-3) combining the set of random data, the user's phone number and the user's encrypted payment details via the trading host, and encrypting the combined data through the use of a private key that is designated to and stored in the trading host, allowing the encrypted combined data to be transmitted to the transaction host;
(9-4) decrypting the encrypted combined data via the transaction host through the use of a public key that is stored in the transaction host and corresponds to a phone number of the trading host, so as to identify the trading host; and decrypting the user's encrypted payment details via the transaction host through the use of a public key that is stored in the transaction host and corresponds to the user's phone number, so as to identify the user providing the payment details; and
(9-5) completing trading performance between the transaction host and the trading host and between the trading host and the user.

16. The phone-mediating trading method of claim 15, wherein step (9-1) comprises the steps of:
(9-1-1) determining if the trading host is successfully linked to the transaction host; if yes, proceeding to step (9-1-2); if no, repeating step (9-1-1);
(9-1-2) obtaining the phone number of the trading host via the transaction host;
(9-1-3) inputting via the trading host a password for initiating trading performance with the transaction host;
(9-1-4) determining via the transaction host according to the phone number of the trading host of the inputted password is correct; if yes, proceeding to step (9-1-6); if no, proceeding to step (9-1-5);
(9-1-5) prohibiting the trading host from performing trading with the transaction host; and
(9-1-6) starting to perform an identification process for the trading host via the transaction host.

17. phone-mediating trading method of claim 15, wherein step (9-4) comprises the steps of:
(9-4-1) decrypting the encrypted combined data via the transaction host through the use of the public key corresponding to the phone number of the trading host, so as to identify the trading host;
(9-4-2) determining via the transaction host if the decrypted set of random data in the decrypted combined data is the same as the original set of random data generated from the transaction host; if yes, proceeding to step (9-4-4); if no, proceeding to step (9-4-3);
(9-4-3) prohibiting the trading host from performing trading with the transaction host as the decrypted set of random data is different from the originally-generated set of random data, which indicates identity of the trading host is incorrect;
(9-4-4) decrypting the encrypted user's payment details through the use of the public key corresponding to the user's phone number via the transaction host so as to identify the user, as the decrypted set of random data is the same as the originally-generated set of random data, which indicates identity of the trading host is correct;
(9-4-5) determining via the transaction host if identity of the user providing the payment details is correct; if no, proceeding to step (9-4-6); if yes, proceeding to step (9-5);
(9-4-6) notifying the trading host of incorrectness in the user's identity via the transaction host, and failing to allow the trading host to perform trading with the transaction host; and
(9-4-7) forwarding a trading-processing message to the trading host via the transaction host.

18. The phone-mediating trading method of claim 17, wherein the trading host is a trader host, and the transaction host is a bank host.

19. The phone-mediating trading method of claim 18, wherein trading between the trader host and the bank host is to perform a billing process via the trader host for the bank host.
